(19) United States
(12) Patent Application Publication
(10) Pub. No.: US 2006/0288633 A1
(43) Pub. Date: Dec. 28, 2006

(54) Float apparatus and method

(76) Inventor: Jeff Lloyd Fiferlick, Sioux Falls, SD (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/168,587

(22) Filed: Jun. 28, 2005

(51) Int. Cl. A01K 93/00

(52) U.S. Cl. 43/44.92; 43/44.87

(57) ABSTRACT

A bobber includes a float portion, and an attachment portion associated with the float. The attachment portion to adapted to receive one of a plurality of components.

### BACKGROUND

For as long as fishermen have been catching fish at the end of a fishing line, various bait and tackle have been available to assist fishermen with their objective. Typically, the various bait and tackle are designed for a particular type of fishing and perhaps, even for a specific type of fish. For example, lures can be drawn through the water to simulate indigenous aquatic life, or bait can simply be affixed to a hook and lowered into the water.

One particularly useful and common fishing aid for bait fishing is the bobber, which is commercially available in a wide variety of shapes and sizes. Not only does a bobber indicate when a fish is nibbling at the bait, but it also enables the fisherman to present the bait at a specific depth with respect to the surface of the water. Part of successful fishing is presenting bait or a lure at the depth at which the fish are located. Once at the appropriate depth, the bait is presented to the fish using a variety of techniques, such as jigging or twitching of the fishing rod or pole. Experienced fishermen typically attach a bobber to the fishing line at a specific distance from the baited end of the line. Since the bait will tend to sink, while the bobber will tend to float, the specific distance between the bobber and the baited end of the line will determine the depth at which the bait will descend in the water.

Floats or bobbers come in many shapes and sizes. Most floats or bobbers are visible during daylight hours but barely visible, or invisible, in low light conditions. Fishing with an unlighted bobber at dusk or after dark is challenging because seeing the bobber or detecting subtle movements thereof can be difficult under low light conditions. Many species of fish feed during the evening or night. For example, the bite associated with feeding might start at twilight as lighting conditions suitable for viewing most floats or bobbers is diminishing.

There are floats or bobbers that are viewable at night; however, these devices have problems. Typically, the daytime type bobber must be replaced with a lighted float or bobber. Switching floats or bobbers can take time during the time when the bite is on. The floats or bobbers can be unreliable, so in addition to the time to switch bobbers, there is a possibility that additional time may be required to make sure the lighting mechanism of the float or bobber is working correctly. Still another problem is that the new float or bobber may be heavier than the previously used bobber. Fish are generally sensitive to a heavy bobber and will “spit” out the bait when such resistance is felt. Another problem encountered when the bobber is switched is that the bobber may be placed at a different level. The bite may be on at one level and a slight difference in height can result in no bite whatsoever.

Many lighted floats or bobbers include internal batteries that must be periodically replaced. These bobbers must be sealed to prevent exposure of the bobber circuitry to the elements. In some instances, these lighted floats or bobbers are unreliable. The fisherman can get the lighted element of the bobber to work when it is in the boat. The fisherman casts the line to a desired spot and the bobber may not stay lit. The fisherman has to then reel in the line and fix the lighted bobber or float. In addition to these bobbers sometimes being unreliable, replacing the batteries, require extra time, particularly at night, in opening and closing the bobber to replace batteries. Anytime the original seal is broken, there is a risk of water leakage into the battery chamber. As this type of bobber or float becomes older, the float or bobber can become increasingly troublesome to operate due to their more exposed and vulnerable components.

Another type of lighted bobber includes a chemiluminescent light source. Typically, a chemiluminescent light source comes in a fixed compartment, such as a tube. The fixed compartment includes a divider to separate a first chemical component from a second chemical compartment. The tube is bent to break the divider and allow the chemicals to mix to produce the light. These light sources have a limited life. These types of floats or bobbers also have problems. The bobbers generally have a fixed weight, which again may be different than a daytime bobber and cause the fish to “spit out” the bait rather than produce a solid bite. Again, the bobber has to be changed from a daytime bobber to a chemiluminescent bobber which can take time during the bite. Still another problem occurs when a bobber or float is used for ice fishing at night. The chemiluminescent portion of the float or bobber is not viewable unless the fisherman is positioned over the top of the ice hole. This can be a problem when the ice fisherman has several ice holes to monitor. Yet another problem is the lack of flexibility of such bobbers.

### BRIEF DESCRIPTION OF THE FIGURES

Embodiments of the present invention are illustrated by way of example and not limitation in the Figures of the accompanying drawings in which:

FIG. 1 is a side view of a fishing system used in open water, according to an example embodiment.

FIG. 2 is a cut-away side view of fishing system used for ice fishing, according to an example embodiment.

FIG. 3 is a side view of a bobber, according to an example embodiment.

FIG. 4 is an exploded view of a bobber, according to an example embodiment.

FIG. 5 is a view of another component, according to an example embodiment.

FIG. 6 is a view of yet another component, according to an example embodiment of the invention.

FIG. 7 is a detailed view of the cylindrical end of the extension attached to the float portion of the bobber, according to an example embodiment.

FIG. 8A is a side view showing of weight, according to an example embodiment.

FIG. 8B is a top view showing of weight, according to an example embodiment.

FIG. 9 is a cut-away side view of a bobber, according to an example embodiment.

FIG. 10 is a side view of a bobber, according to an example embodiment.

### DETAILED DESCRIPTION

A system and method for selecting configuration results from a plurality of candidate configuration designs are described herein. In the following description, numerous specific details are set forth. The following description and the drawing figures illustrate aspects and embodiments of the invention sufficiently to enable those skilled in the art. Other embodiments may incorporate structural, logical, electrical, process, and other changes; e.g., functions described as software may be performed in hardware and vice versa. Examples merely typify possible variations, and are not limiting. Individual components and functions may be optional, and the sequence of operations may vary or run in parallel. Portions and features of some embodiments may be included in, substituted for, and/or added to those of others. The scope of the embodied subject matter encompasses the full ambit of the claims and substantially all available equivalents.

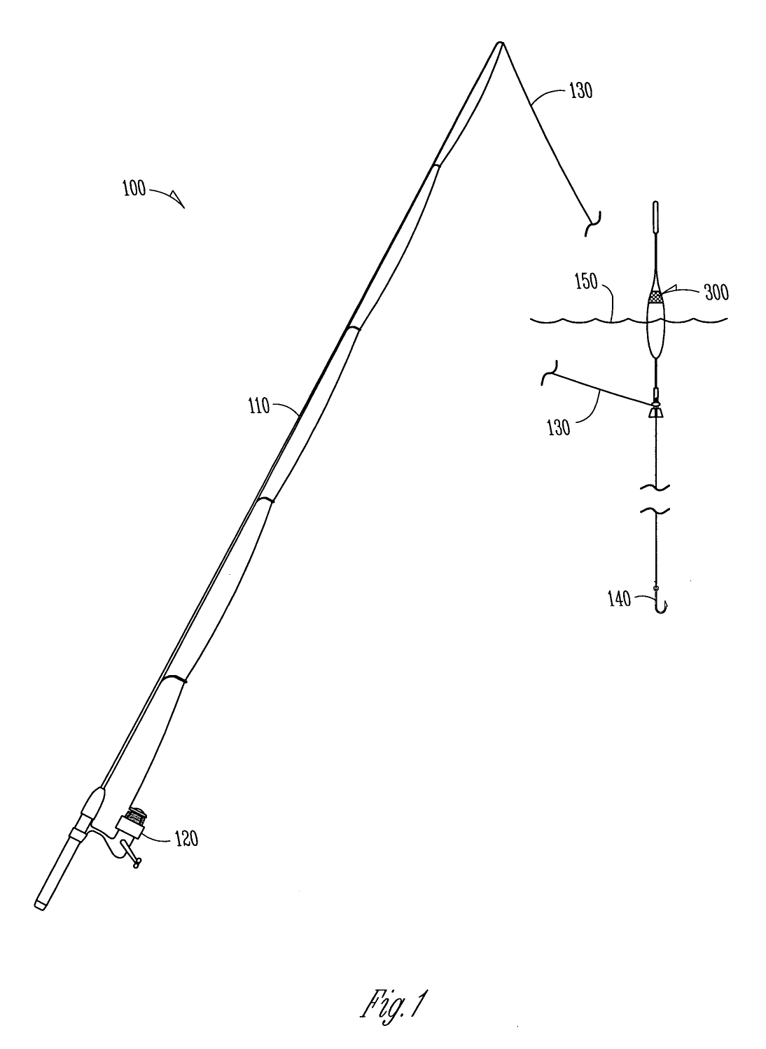

FIG. 1 is a side view of a fishing system 100 used in open water, according to an example embodiment. The fishing system 100 includes a rod 110 and reel 120. The reel 120 holds fishing line, such as monofilament fishing line 130. The reel 120 is capable of holding many yards of fishing line 130. The reel is also capable of letting out and reeling in various lengths of the line 130. Attached to the line 130 is a fishing lure 140. Also attached to the line 130 is a bobber 300. The bobber 300 is used to maintain the fishing lure 140 at a specific depth with respect to the surface of a body of water 150.

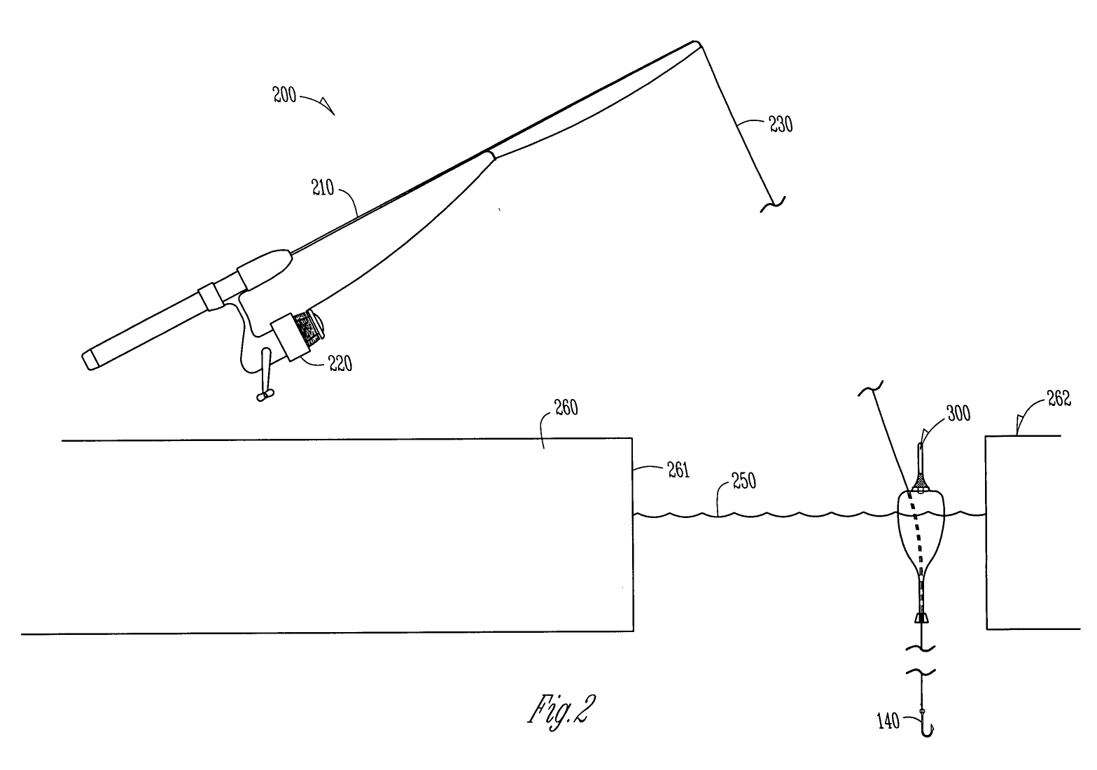

FIG. 2 is a cut-away side view of a fishing system 200 used for ice fishing, according to an example embodiment. The ice fishing system 200 includes a rod 210, a reel 220 and a line 230. Attached to the end of the line is a lure 140. Also attached to the line 230 is a bobber 300. The bobber 300 maintains the lure 140 at a specific depth with respect to a water level in a body of water 250. In some climates, a body of water freezes over forming a layer of ice 260 over the body of water 250. An opening 261 is formed in the layer of ice 260. The opening 261 is many times referred to an ice hole. The bobber 300 has a portion that extends to a level above a top level 262 of the layer of ice 260. In this way, the bobber 300 can be viewed or seen from a position other than a view from the top of the ice hole, or opening 261. This is useful when an ice fisherman is maintaining a plurality of rods and reels or lines in several ice holes, such as ice opening or hole 261 that are separated from one another. Having a portion of the bobber 300 extend above the top surface 262 of the ice layer 260, allows the ice fisherman to determine when a bite is occurring even though the ice fisherman may be remotely located with respect to the ice opening 261 in the ice layer 260.

It should be noted that the component 400 also includes textured surfaces. For example, the tube 412 which contains the light 410 is textured with a knurl pattern. Near the threaded end 430, the component 400 is also textured. Any type of texturing can be used in the texturing, enables a user, such as a fisherman, to more easily grip the component and apply the necessary torque to attach the component 400 to the float portion or float 310.

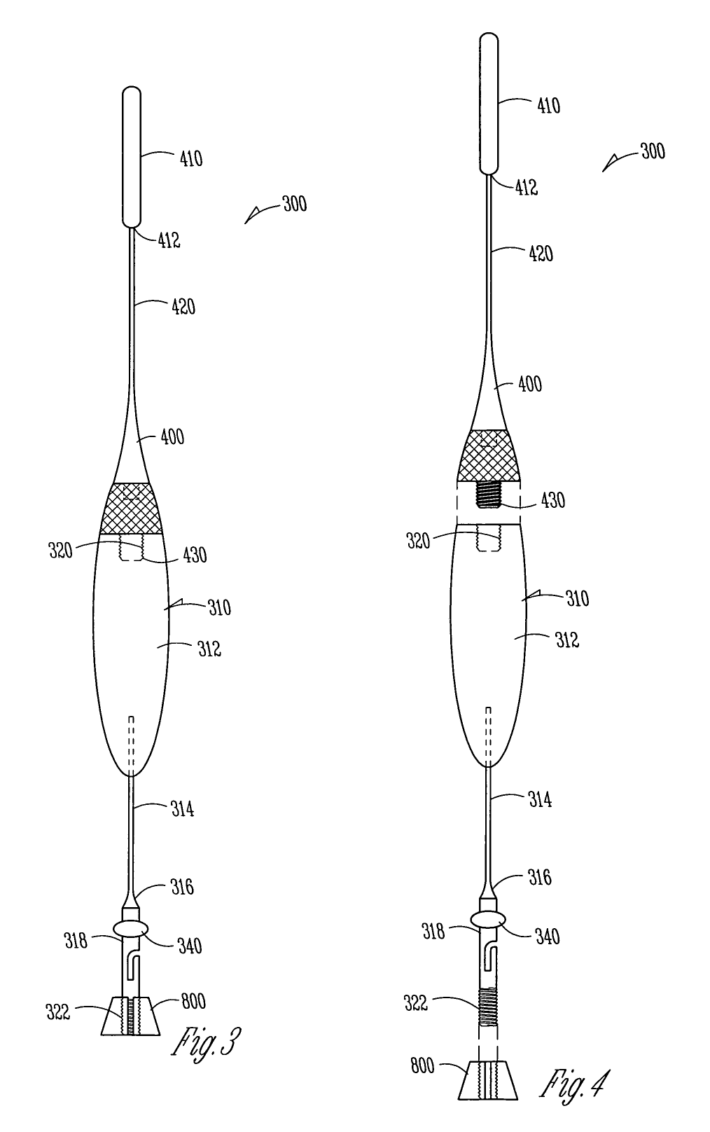

FIG. 3 is a side view of a bobber 300, according to an example embodiment. FIG. 4 is an exploded view of the bobber 300 shown in FIG. 3. Now referring to both FIGS. 3 and 4, the bobber 300 will be further detailed. The bobber 300 includes a float portion 310, a light portion 400, and a weight portion 800. The float portion 310 includes a first attachment portion 320 and a second attachment portion 322. The attachment portions 320, 322 can feature any type of fastening mechanism. As shown in FIG. 3, the first attachment portion 320 is a male threaded portion and second attachment portion 322 is a female threaded portion. The first attachment portion 320 is adapted to receive one of a plurality of components, such as light portion 400. Light portion 400 includes a light 410, a stem 420 and a threaded end 430. The threaded end 430 is a male thread portion, which is sized to attach to the first attachment portion 320 of the float portion 310.

The light 410 can be any type of light or luminous paint or the like. In this particular embodiment, the light is a chemiluminescent light source. A chemiluminescent light source includes a tubular element 412 which holds a first chemical and a second chemical. The tube 412 includes a divider to separate the first chemical component from the second chemical component. By slightly bending the tube 412, the divider or dividers separating the first chemical from the second chemical are broken, thus allowing the first chemical component and the second chemical component to mix. Upon the first chemical component mixing with the second chemical component produces a chemical reaction that produces light within the tube 412. The chemical reaction typically will produce a light anywhere in the range of 6 to 9 hours after the tube 412 has been bent. It is contemplated that other chemiluminescent sources of light may be developed that produce light for a longer duration. A chemiluminescent light source will continue to work in cold conditions. In fact, when a chemiluminescent light source is exposed to low or freezing temperatures, the chemiluminescent light source will last longer, although it will not glow as brightly as a warmer chemiluminescent light source. In some embodiments, the chemiluminescent light is covered with a removable barrier that substantially blocks light. This prevents any degradation of the light source from, for example, exposure to sunlight. The barrier would include a foil to substantially prevent exposure to sunlight. The barrier could also be painted or include dyes so that the exterior portion of the barrier would be of a selected color. The barrier could also be placed on the chemiluminescent light using an adhesive to form a barrier that would stay in place while in the water. The barrier could also be vacuum sealed to the light source. In operation, the bobber could be used during the day and then, as daylight begins to end the fisherman would remove or peel off the barrier and bend the chemiluminescent light to mix the chemicals and enable the light. Once the container of chemiluminescent light source is manipulated to mix the chemicals, the light source lasts for the duration of the chemical reaction. Operation of the bobber is simplified since there is no turning off of the light source that the fisherman is required to remember.

The stem 420 elevates the light with respect to the threaded end 430 and with respect to the float portion 310. The stem 420 can be of various lengths. Furthermore, various light portions 400 can be attached to the float 310. The various light portions or components 400 can have stems 420 of various lengths. This can be useful in ice fishing when the bobber 300 is used in an ice hole and the water level associated with the body of water is below the top level of the ice 262 (as shown in FIG. 2). Various components or light portions 400 can be used to accommodate various thicknesses of ice and the stems 420 would be of sufficient length to elevate the light 410 of the component 400 to a point where it is visible above the surface 262 of a layer of ice 260, while the bobber 300 is floating in the body of water. It should also be noted that although tubular light sources are shown, any size or shape of light source is contemplated as part of the invention.

It should be noted that the light is not limited to a chemiluminescent light source. The light source could be a dye or paint that includes a luminescent light source. For example, paints or dyes that glow after being exposed to various types of light could also be used. It should also be noted that the stems 420 of the component 400 could be fixed with respect to the light source or could be switchable.

The float portion 310 has a body of buoyant material 312. It should be noted that any type of buoyant material may be used, including balsa wood, Styrofoam or a hollow plastic portion, or the like. Attached to the body of buoyant material 312 is an extension 314. The extension 314 is attached to one end of the body of buoyant material 312. The extension 314 can be made of any material, such as solid plastic, fiberglass, wood, foam, metal, or composite material or the like. In the example embodiment, shown in FIG. 3, the extension is a wire coated with plastic. The first attachment portion 320 is attached to or associated with the other end of the body of buoyant material 312. The extension 314 includes the threaded end 322. The extension 314 actually flares out near the threaded end 322. The flared out portion 316 also includes a cylindrical portion 318. The threaded end 322-is attached to the cylindrical portion 318. The cylindrical portion 318 also carries a stop, such as a rubber ball slide 340. The rubber ball slide 340 has an opening therein. The rubber ball slide 340 therefore slides over various portions of the cylindrical portion 318 of the extension 314. It should be noted that the stop can be any type of stop made of any shape or type of material. The second attachment portion 322 is a threaded end. The weight 800 includes a female threaded portion sized to receive the threaded end, or second attachment end 322 of the bobber 300. The way it is another component which can be changed out or interchanged with other sized weights, depending upon the application of the bobber 300 in various fishing systems and situations. The weight 800 is essentially conical in shape. The weight 800 can be of various values.

The cylindrical end 318 includes various features which will be described in further detail below. By sliding the rubber slide 340 to various positions over the cylindrical portion 318 and the features in the cylindrical portion. The bobber can be used as a side slip bobber, or as a fixed line bobber.

FIG. 5 is a view of another light portion, or component 500, according to an example embodiment. The component 500 includes a tube 512 for holding a chemiluminescent. The component 500 also includes a threaded end 530. Near the threaded end 530 is a flared out textured portion 540. The textured portion 540, as shown in FIG. 5, is a knurled pattern. It should be noted that any textured surface can be used and is not limited to a knurled pattern. The textured surface 540 prevents slippage of a user's fingers when the component 500 is being placed into the attachment portion 320 of the float portion 310 of the bobber 300. The threaded end 530 has a thread pattern and size so that it mates with the female threaded portion associated with the first attachment portion 320 of the body of buoyant material 312.

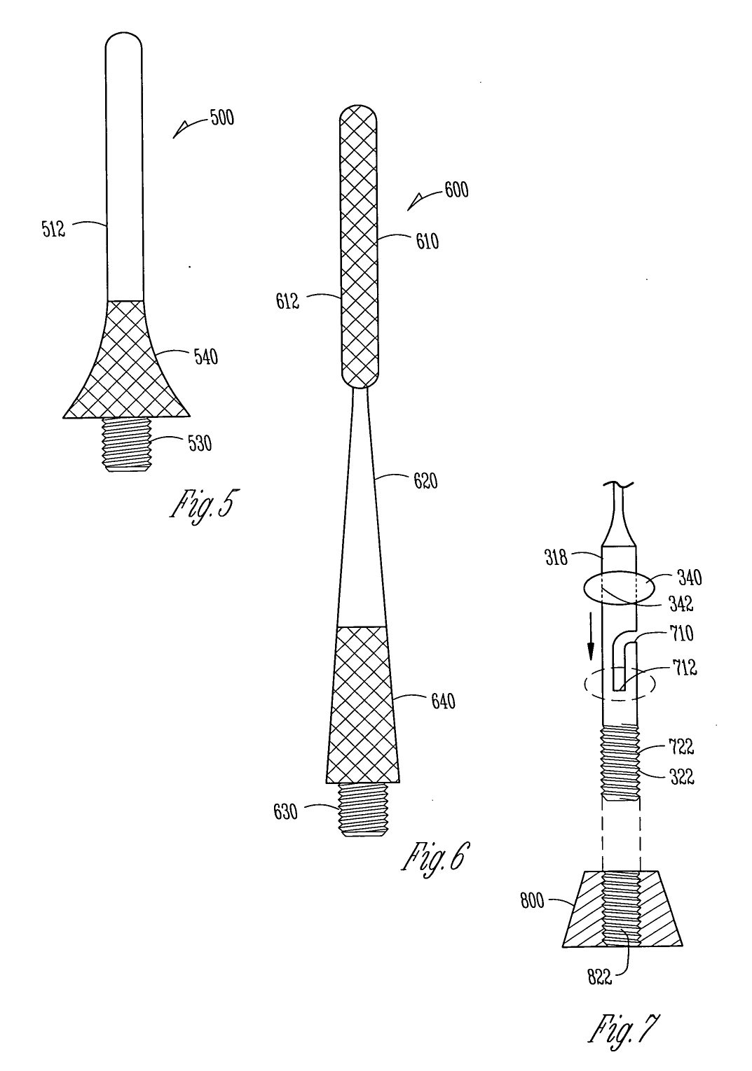

FIG. 6 is a view of yet another component 600, according to an embodiment of the invention. The component 600 replaces the component 400 to produce yet another arrangement for a bobber, such as bobber 300, shown in FIGS. 3 and 4. The component 600 includes a light portion 610 which is housed within a tube 612 which is located at one end of the component 600. The other end of the component includes a threaded end 630. As shown in FIG. 6, the attachment end 630 is a male threaded portion. The component 600 also includes a stem 620 which extends between the threaded end 630 and the light portion 610. The stem elevates the light with respect to the float portion 310 of the bobber. FIGS. 3, 4, 5 and 6 illustrate various components 400, 500, 600 which can be interchanged and attached to the float portion 310 of the bobber to form differently arranged bobbers. The components 400, 500, 600 are just three examples of components which may be added or interchangeably attached to the body of buoyant material 312 of the float 310 to form a different bobber arrangement for a different application.

FIG. 7 is a detailed view of the cylindrical end 318 of the extension 314 that is attached to the float portion 310 of the bobber, according to an example embodiment. The cylindrical end includes an L-shaped opening 710. The rubber ball slide 340 includes a cylindrical opening 342 therein which allows the rubber slide 340 to slide over the cylindrical portion 318. A line can be placed into the L-shaped slot 710. The rubber ball slide 340 can then be slid over the L-shaped opening to form either a side slip bobber arrangement or a fixed line bobber arrangement the rubber ball slide 340 is positioned over a portion of the L-shaped opening 710 in the side slip arrangement. In the side slip arrangement the rubber ball slide 340 does not pinch or grab the line. In other words, the rubber ball slide 340 is placed over the L-shaped slot 710 so that an opening 712 is created between the uncovered portion of the L-shaped slot 710 and the rubber ball slide 340. The opening 712 is large enough to allow the line to slip through or pass through the opening freely. The line can be provided with a stop which can be slid on the line. The stop typically is larger than the opening 712 formed by the uncovered portion of the L-shaped slot 710 so that the bobber will slip with respect to the line until the line stop is encountered. By sliding the rubber ball slide 340 so that it pinches the line and essentially covers the L-shaped slot 712, the bobber is then-is a fixed position with respect to the line. As shown in FIG. 7, the cylindrical portion 318 also includes male threads 722 associated with the second attachment means of the bobber 300. The weight 800 also includes a threaded portion 822. The threaded portion 822 engages the threaded 722 so that the lead weight 800 can be attached to the cylindrical portion 318 of the bobber 300.

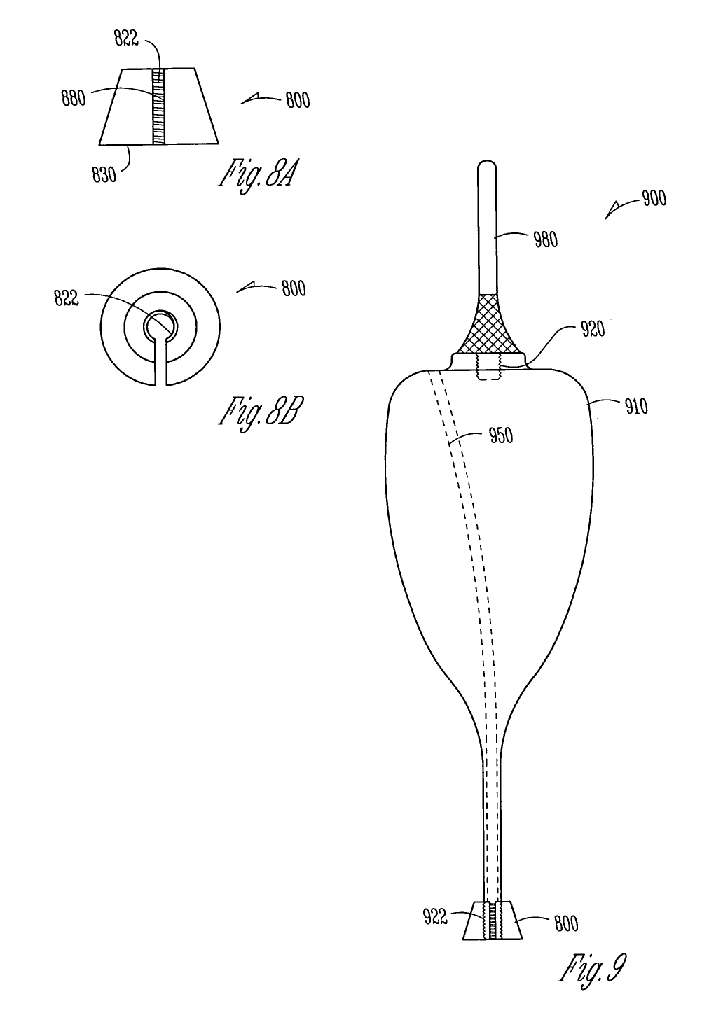

FIGS. 8A, and 8B will now be referred to further detail the weight 800, according to an example embodiment. FIG. 8A is a side view of a weight, and FIG. 8B is a top view of a weight 800. The weight 800 is essentially frusto-conically shaped. The weight 800 includes a female threaded portion 822 which engages the second attachment portion 322 of the float portion 310 of the bobber 300 (shown in FIGS. 3 and 4). The cylindrical portion 318 of the extension 314 of the bobber 300 includes threads 722 (see FIGS. 3, 4 and 7). The weight 800 includes a bottom surface 830. Therefore, the weights can be attached to the cylindrical end 318 or threads 722 of the cylindrical end 318 of the extension 314 of the bobber 300. The weight 800 includes a slit or slot 880. The slit or slot 880 allows weights to be changed on the bobber without having to cut the fishing line. It should be noted that the weight is another component which can be attached to the bobber 300 (shown in FIGS. 3 and 4).

The weight can be of various sizes such as ⅛ ounce, ¼ ounce, ⅜ ounce, ⅝ ounce, ½ ounce, 1 ounce, or any other desirable size. The weight can be made of any material, such as lead, brass, steel, copper, an alloy material or the like. Of course, the larger the weight, the larger the body of buoyant material must be in order to counteract the weight. It should be noted that the weight can be interchanged so that the fish will not feel as much resistance on the line when biting the lure 140, presented to the aquatic life form, such as a fish. The body of buoyant material 312 associated with the float portion 310 generally produces an upwardly directed force of buoyancy when floating in the water. The weight 800 will counter this buoyancy force by producing a downward force due to gravity. By counteracting the force of buoyancy with the weight, the fish when biting on the lure or hook 140 will feel less resistance. This is helpful in fishing since many fish are very sensitive to a high buoyancy force. For example, in ice fishing, generally a tiny bobber is used to maintain or present the lure or hook at a selected level below the surface of the ice and below the surface of the water. The small bobber therefore produces a small buoyancy force so that when the fish strikes the lure or nibbles on-the bait attached to the lure 140, they will be less likely to spit out the bait since little if any resistance is noticed by the fish. Thus by providing an adjustable weight which can be made larger or smaller, the effective buoyancy force presented at the hook or lure 140 can be made quite small. Also the size of the bobber 300 can be made fairly large so that it's more easily seen in various conditions. For example, in ice fishing it is advantageous to have the light portion 410 of the bobber 300 (shown in FIGS. 3 and 4), placed or presented above the surface of the ice so that the fisherman can easily monitor whether or not a fish is nibbling or biting on a lure attached to a line associated with the bobber during the nighttime hours. Also, the weight 800 acts to stabilize the bobber 300 while it is in use. Even though the component 400, 500, 600 made to minimize wind forces, wind forces will still act on the component 400, 500, 600. The weight 800 is placed on the extension 314 at a distance that will counteract any torque produced by the wind on the bobber. Thus the weight placed fairly low below the body buoyant material 312 or float 310 of the bobber 300 serves as a stabilizer. In addition, the plastic coated wire of the extension 314 can be easily bent to make sure that the component 400, 500, or 600, which is attached to the float portion 310 of the bobber 300, remains substantially upright when there is little or no wind present.

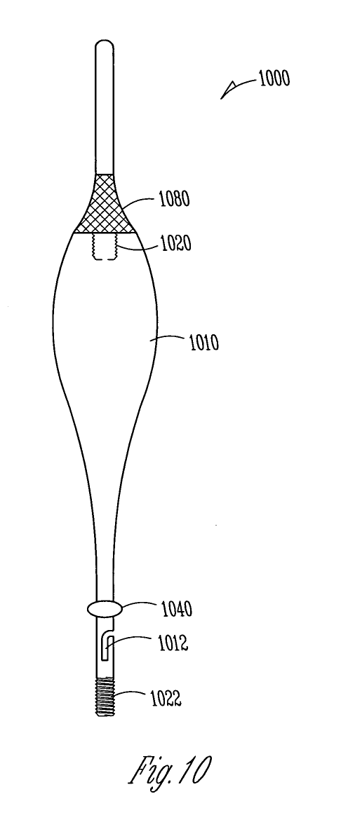

FIG. 9 is a side view of a bobber 900. The bobber 900 includes a float portion 910 and a first component 980 and a weight 800. The float 910 includes a first attachment portion 920 and a second attachment portion 922. The first attachment portion 920 includes a set of female threads. The second attachment portion 922 includes a set of male threads. The weight 800 is interchangeable so that the total weight attached to the second attachment portion can be varied by interchanging weights 800 of various sizes. The component 980 can include a colored stick having a highly visible color for daylight use or can include a chem-light or chemiluminescent light source.

The float portion 910 also includes an opening or channel 950 therein. The channel 950 is sized to receive a line, or fishing line. Thus the bobber 900 can be used as a slip bobber. A slip bobber stops when a bobber stop is encountered on a fishing line. The slip bobbers are very useful in applications where a bait or lure is to be presented at a specific distance below the surface of water and the fisherman or angler must cast the line, lure and bobber out for a distance. The bobber can then slip to a position near the lure so that the arrangement can be easily cast. The lure then drops with respect to the bobber as the line feeds through the channel 950 until a bobber stop is encountered on the fishing line. In some embodiments of the invention, a cylindrical portion 918 near the end that includes the second attachment portion 922 also includes an L-shaped opening, similar to the one shown and described in FIG. 7. Therefore, the bobber 900 can function as a slip bobber, a side slip bobber or as a fixed position bobber. It functions as a slip bobber when the line is placed through the channel 950. The line can then also be placed into an L-shaped opening and the rubber ball slide 340 can be moved in a position that covers a portion or all of the L-shaped slot 710 (see FIG. 7 and related discussion).

The bobber 900, more specifically the float portion 910, can be made of any buoyant material. As shown in FIG. 9, the float portion 910 is made of a foam or Styrofoam material. The other types of material including balsa or any other type of buoyant material can be used in this embodiment of the bobber 900. In use, this bobber can be set up as either a slip bobber, a side slip bobber, or a fixed line bobber. Different weights can be attached to the second attachment portion 922 so that the resistance force felt by nibbling fish can be made small, so that the bobber floats correctly on the surface of the water. A colored component of a highly visible color 980 can be attached to the first attachment portion 920 of the float 910 during the day. As dusk arrives and the highly visible color becomes difficult to see in low light conditions, the colored component 980 can be swapped out quickly with a component 980 that includes a chem-light. The chem-light can be slightly bent, therefore activating the chemical reaction that produces light and the angler can be fishing very quickly.

In another embodiment or method, a fisherman or angler may choose to use the component 980 that includes a chem-light or chemiluminescent light source during the day. At dusk the fisherman would merely reel in his line, bend the tube associated with the component 980 to activate the chemiluminescent light source and then return to fishing. This prevents fumbling around and missing a big bite during critical fishing time. It is also convenient. In another embodiment, the component 980 can include a chemiluminescent light source and a portion of the tube of the chemiluminescent light source can be provided with a highly visible color. For example, the top or tip or free end of the chemiluminescent light source can be painted with a chartreuse or fluorescent red. The chemiluminescent light source may also include a tip on the free end having a highly visible color. This will be visible during the day and when low light conditions occur, the chemiluminescent light source, the angler can reel in the line, bend the component 980 to activate the chemiluminescent light source and then be fishing once again.

FIG. 10 is aside view of a bobber 1000, according to an example embodiment. The bobber 1000 includes a float portion 1010. Attached to the float portion 1010 is a first component 1080. The bobber also includes a first attachment portion 1020 and a second attachment portion 1022. The first attachment portion 1020 receives a mating attachment portion associated with the component 1080. The component 1080 includes a knurled, or textured, surface to ease the attachment of the component 1080 to the float portion 1010. The second attachment portion 1022 includes a threaded end. The threaded end is sized to receive various sizes of weights. Near the threaded end or second attachment portion 1022 is a cylindrical portion that includes an L-shaped slot 1012. The bobber 1000 also includes a rubber ball slide 1040. A fishing line, such as line 130 or line 230, is then placed into the slot 1012. The rubber ball slide 1040 can be slid to a position to either partially or totally cover the L-shaped slit 1012. Depending upon the position of the rubber ball slide 1040, the bobber 1000 either functions as a side slip bobber or as a fixed line bobber.

It should be noted that the bobber or float portion of the bobber can be made in various shapes and sizes and still be within the scope of this invention. The float can include any shape. The bobber can be made to be as a slide slip or fixed line bobber or as a slip type bobber and still be within the scope of the invention. The float portion 310, 910, 1010 includes a first attachment portion and a second attachment portion. Various components can be attached to the first attachment portion to produce a bobber arrangement that is visible during the day or visible during the night or visible during both times. Attached to the other attachment portion are various weights which can be used to counteract the buoyant force of the bobber and, therefore adjusting the resistance that a fish or aquatic animal nibbling on the bait or taking the bait will feel at a lure 140 (shown in FIGS. 1 and 2).

A component 400, 500, 500 can include a light for a bobber 300. The component can also include an elongated light holding apparatus or stem 420. The light holding apparatus includes a tube for holding a first chemical component and a second chemical component. The component 300, 400, 500 for the bobber also includes a fastener positioned on an end of the elongated light holding apparatus. The fastener is adapted to fasten to a float of a bobber. In another embodiment, the fastener is attached to the tube for holding the first chemical component and the second chemical component. In some embodiments, the light for the bobber also includes a stem attached to the tube. The fastener is attached to the stem. In still other embodiments, the tube includes a textured portion.

A bobber system includes a float portion, a first interchangeable portion removably attached to the float portion, and a second interchangeable portion removably attached to the float portion. The first interchangeable portion includes a light, and the second interchangeable portion includes a weight. In another embodiment, the first interchangeable portion includes a light, and a stem for elevating the light with respect to the stem portion. In still other embodiments, the second interchangeable portion includes a weight, and an extension for the weight. In some embodiments, the bobber has a hollow channel therein. The hollow channel allows the bobber to move over a line. In another embodiment, the extension of the bobber system includes a mechanism for fixing the bobber with respect to a line.

Although the present invention has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense.

1. A bobber comprising:
a float portion; and
an attachment portion associated with the float adapted to receive one of a plurality of components.

2. The bobber of claim 1 wherein one of a plurality of components includes a light.

3. The bobber of claim 1 wherein one of a plurality of components includes a light having a second attachment portion that attaches to the attachment portion of the float.

4. The bobber of claim 3 wherein the light is produced by a chemical reaction.

5. The bobber of claim 3 wherein the light is attached to a stem to elevate the light with respect to the float portion of the bobber.

6. The bobber of claim 5 wherein the stem includes a second attachment portion that attaches to the attachment portion of the float.

7. The bobber of claim 1 wherein one of a plurality of components includes one of a plurality of weights.

8. The bobber of claim 7 wherein the plurality of weights have different measures of weight.

9. The bobber of claim 7 wherein at least one of a plurality of weights has a second attachment portion that attaches to the attachment portion of the float.

10. The bobber of claim 7 further comprising an extension, at least one of a plurality of weights is affixed to the extension, the extension further including a second attachment portion that attaches to the attachment portion of the float.

11. A bobber system comprising:
a float portion;
an first interchangeable portion removably attached to the float portion; and
a second interchangeable portion removably attached to the float portion.

12. The system of claim 11 wherein the first interchangeable portion includes a light, and the second interchangeable portion includes a weight.

13. The system of claim 11 wherein the first interchangeable portion further comprises;
a light; and
a stem for elevating the light with respect to the stem portion.

14. The system of claim 11 wherein the second interchangeable portion further comprises;
a weight; and
an extension for the weight.

15. The system of claim 11 wherein the bobber has a hollow channel therein so that the bobber is adapted to move over a line.

16. The system of claim 15 wherein the extension further comprises a mechanism for fixing the bobber with respect to a line.

17. A light for a bobber comprising:
an elongated light holding apparatus including a tube for holding a first chemical component and a second chemical component; and
a fastener positioned on an end of the elongated light holding apparatus, the fastener adapted to fasten to a float of a bobber.

18. The light for a bobber of claim 17 wherein the fastener is attached to the tube for holding the first chemical component and the second chemical component.

19. The light for a bobber of claim 17 further comprising a stem attached to the tube, wherein the fastener is attached to the stem.

20. The light for a bobber of claim 17 wherein the tube includes a textured portion.
